(19) United States
(12) Patent Application Publication
(10) Pub. No.: US 2017/0338925 A1
(43) Pub. Date: Nov. 23, 2017

(54) SCHEDULING METHOD OF COMMUNICATION SYSTEM USING DIRECTIONAL REFERENCE SIGNALS AND RELATED APPARATUSES USING THE SAME

(71) Applicants: National Taiwan University, Taipei (TW); MediaTek Inc., Hsinchu (TW)

(72) Inventors: Hung-Yu Wei, Taipei (TW); Chung-Wei Weng, Kaohsiung City (TW); Ching-Chun Chou, Taipei City (TW)

(73) Assignees: National Taiwan University, Taipei (TW); MediaTek Inc., Hsinchu (TW)

(21) Appl. No.: 15/452,748

(22) Filed: Mar. 8, 2017

Related U.S. Application Data
(60) Provisional application No. 62/339,112, filed on May 20, 2016.

(51) Int. Cl. H04L 5/00; H04W 52/02; H04W 72/04; H04W 72/12

(52) U.S. Cl. CPC H04L 5/0048; H04W 72/1289; H04W 52/0229; H04W 72/0446; H04W 72/1284

(57) ABSTRACT

The disclosure is directed to a scheduling method of a communication system that uses directional reference signals and related apparatuses using the same. In one of the exemplary embodiments, the proposed scheduling method is used by a UE that receives directional reference signals. The method would include not limited to: receiving a first reference signal before a first time period; entering into a first schedulable period at the first time period after receiving the first reference signal; entering into a power saving mode in a second time period which is immediately after the first time period; receiving a second reference signal before a third time period; entering into a second schedulable period at the third time period after receiving the second reference signal; and entering into the power saving mode in a fourth time period which is immediately after the third time period.

### CROSS REFERENCE TO RELATED APPLICATION

This application claims the priority benefit of U.S.A. provisional application Ser. No. 62/339,112 filed on May 20, 2016. The entirety of the above-mentioned patent application is hereby incorporated by reference herein and made a part of specification.

### TECHNICAL FIELD

The disclosure is directed to a scheduling method of a communication system that uses directional reference signals and related apparatuses using the same.

### BACKGROUND

As The Millimeter Wave (mm-Wave) communication is an emerging technology endowed with large spectrum resources as the technology operates on one or more frequency bands between 30 GHz and 300 GHz. Radio transmissions under such high frequencies would result in large free-space loss for the transmissions. Since the short wavelengths of mm-Wave signals would result in short spacing between antenna elements, the quantity of antenna element packings in an antenna module may escalate as the result of the increase of operating frequency. Consequently, dense antenna elements may result in antenna arrays having radiation patterns with high directivity and large beamforming antenna gains. According to Friis free-space equation, a directional antenna with a high antenna gain would be able to make up the free-space path loss. Recent studies have also shown that high gain antenna is able to overcome the free-space loss achieving over 100 m communication range, even in non-line-of-sight (NLoS) channels.

However, wireless communications using directional antennas would require transmissions in appropriate directions. As the Millimeter Wave technology would likely be adopted as the communication technology of the next generation, a base station operating under millimeter waves would be required to strategically design directional antennas to concentrate transmission powers in particular directions in order to provide the optimum coverage. As an example, FIG. 1 illustrates a communication system which uses directional wireless transmission. In the example of FIG. 1, a base station 101 may serve an individual user equipment (UE) such as a mobile phone 102 or a vehicle 104 or may serve UEs operating within a network such as a device to device (D2D) communication network 103 with millimeter waves. In such scenario, a base station would need to know which direction to transmit in order to cover all the UEs because antennas having directivities are required in order to mitigate severe path losses as previously mentioned. Therefore, the direction or position in the angular domain of each of the UEs relative to the base station would need to be known. Also, a base station would need to know the condition of channels between the base station 101 and UEs 102, 103, 104 in order to allocate resources for the UEs.

To obtain the direction of UEs and conditions of channels, a base station conventionally rely upon transmitting reference signals in exchange for channel condition information received from UEs. FIG. 2 illustrates an example of transmitting a reference signal (RS) from a base station 201 and receiving of the reference signal by a UE 202. In response to receiving reference signal, the UE may perform channel estimation (e.g. channel quality indicator (CQI) measurement) and then transmit a feedback signal (S1) to the base station 201. Overall, the process of FIG. 2 could also be used for collecting information about the radio frequency (RF) beam which is used to serve the UE 202 in addition to the measurement of the channel condition between the base station 201 and the UE 202. Consequently, the UE 202 may perform a mm-Wave cell search based on the reference signal (RS), and the base station 201 may be able to perform beam training or beam track based on the feedback signal (S1) from the UE 202.

The reference signaling mechanism of FIG. 2 would be able to support cell discoveries and channel measurements. However, in general, if a base station uses an omni-directional mm-Wave for signaling, the range of the signaling would be shorter than using a directional mm-Wave for signaling, assuming that the maximum transmission power of a base station is a constant. This would potentially lead to the control channels and the data channels having different transmission ranges. If a UE uses directional reception in mm-Wave for reference signaling, it may require beam alignments between a base station and a UE and thus would lead to large overheads.

FIG. 3 illustrate an example of transmitting directional specific reference signals from a base station for a plurality of user equipment situated in different locations. FIG. 3 assumes a 2-dimensional horizontal plot (X-Y plane) relative to the earth's surface. In a typical mm-Wave communication system, a base station 301 may need to serve multiple UEs 311, 312, 313, 314 located in various locations around the base station 301. In order to serve UEs 311, 312, 313, 314, the base station 301 would need to know which beam would best serve any particular UEs 311, 312, 313, 314. More specifically, the base station 301 would need to know the direction of the UEs 311, 312, 313, 314 as well as the channel conditions of each of the UEs 311, 312, 313, 314. This could be accomplished by the reference signal mechanism of FIG. 2. A base station 301 may either transmit reference signals through directional beams of different angles or perform an omni-directional transmission for reference signals.

FIG. 4 illustrates an example of transmitting a single directional reference signal from a base station in comparison to transmitting multiple directional reference signals. Assuming that the maximum overall transmission power used by a base station is constant, omni-directional transmission would have a shorter range; whereas a directional RF beam, though having a longer transmission range, would only cover a specific direction instead of all directions. As shown in FIG. 4, having multiple simultaneous directional beams would incur reduced power for each simultaneous beam relative to a single directional beam assuming that power is equally shared among each simultaneous beam. Thus in FIG. 4, there is more power and greater range in the single RF beam used by the base station 401 to scan UE 411 than the each of the four beams used to scan four UEs 411 412 413 414 simultaneously.

From the directional reference signal schemes as previously described, it can be seen from FIG. 3 and FIG. 4 that there is a channel information feedback delay after reference signal measurements are performed for each beams which contain the reference signals. Such feedback delay as the result of the UE 202 performing measurements and subsequently transmitting the result of the measurements back to the base station 201 may result in performing degradation for scheduling. Consequently, the time difference between channel measurement and data scheduling caused by the feedback delay as described above may result in transmission failure. Also different dormant mechanism used for scheduling may affect power efficiencies. Further, different reference signal sweeping schemes and different scheduling schemes would result in different power efficiencies. Therefore, how a base station would schedule UEs for services in a wireless communication system that uses directional reference signals would still be a design challenge.

### SUMMARY OF THE DISCLOSURE

Accordingly, the disclosure is directed to a scheduling method of a communication system that uses directional reference signals and related apparatuses using the same.

In one of the exemplary embodiments, the disclosure is directed to a scheduling method used by a UE that receives directional reference signals. The method would include not limited to: receiving a first reference signal before a first period; entering into a first schedulable period at the first time period after receiving the first reference signal; entering into a power saving mode in a second time period which is immediately after the first time period; receiving a second reference signal before a third time period; entering into a second schedulable period at the third time period after receiving the second reference signal; and entering into the power saving mode in a fourth time period which is immediately after the third time period.

In one of the exemplary embodiment, the disclosure is directed to a scheduling method used by a base station that transmits directional reference signals. The method would include not limited to: transmitting a first reference signal before a first time period; transmitting a first user data in a first schedulable period at the first time period after transmitting the first reference signal; stopping transmitting the first user data after the first schedulable period a second time period which is immediately after the first time period; transmitting a second reference signal before a third time period; transmitting a second user data at the third time period after transmitting the second reference signal; and stopping transmitting the second user data in a fourth time period which is immediately after the third time period.

In one of the exemplary embodiment, the disclosure is directed to a user equipment. The user equipment would include not limited to a transmitter, a receiver, and a processing circuit coupled to the transmitter and the receiver. The processor circuit is configured at least to: receive, via the receiver, a first reference signal before a first time period; receive, via the receiver, a first user data at the first time period after receiving the first reference signal; enter into a power saving mode in a second time period which is immediately after the first time period; receive, via the receiver, a second reference signal before a third time period; receive, via the receiver, a second user data at the third time period after receiving the second reference signal; and enter into the power saving mode in a fourth time period which is immediately after the third time period.

In order to make the aforementioned features and advantages of the disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the disclosure and is therefore not meant to be limiting or restrictive in any manner. Also the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a communication system which uses Millimeter Wave technology as an example.

FIG. 2 illustrates an example of transmitting a reference signal from a base station and receiving of the reference signal by a user equipment.

FIG. 3 illustrates an example of transmitting reference signals, which are direction specific, from a base station for a plurality of user equipment situated in different locations.

FIG. 4 illustrates an example of transmitting a single directional reference signal from a base station in comparison with transmitting multiple directional reference signals.

FIG. 5 is conceptual diagram which illustrates the proposed scheduling method used by a UE that receives directional reference signals in accordance with one of the exemplary embodiments of the disclosure.

FIG. 6 illustrates transmissions of directional reference signals in accordance with one of the exemplary embodiments of the disclosure.

FIG. 7 illustrates the proposed scheduling method used by a UE that receives directional reference signals with more details in accordance with one of the exemplary embodiments of the disclosure.

FIG. 8 illustrates schedulable time for each UE in accordance with one of the exemplary embodiments of the disclosure.

FIG. 9 illustrates determining schedulable device sets in accordance with one of the exemplary embodiments of the disclosure.

FIG. 10 illustrates determining schedulable time according to reference signal beam groups in accordance with one of the exemplary embodiments of the disclosure.

FIG. 11 illustrates determining schedulable device sets according to reference signal beam groups in accordance with one of the exemplary embodiments of the disclosure.

FIG. 12 illustrates fixed length schedulable time in accordance with one of the exemplary embodiments of the disclosure.

FIG. 13 illustrates variable length schedulable time in accordance with one of the exemplary embodiments of the disclosure.

FIG. 14 illustrates a signaling diagram of a BS assigning schedulable time on PDCCH in accordance with one of the exemplary embodiments of the disclosure.

FIG. 15 illustrates a signaling diagram of a UE reporting schedulable time on PUCCH in accordance with one of the exemplary embodiments of the disclosure.

FIG. 16 illustrates a signaling diagram of using SIB for scheduling after RRC connection setup in accordance with one of the exemplary embodiments of the disclosure.

FIG. 17 illustrates a signaling diagram of using SIB for scheduling before RRC connection setup in accordance with one of the exemplary embodiments of the disclosure.

FIG. 18 illustrates a first exemplary embodiment of the proposed scheduling method in accordance with the disclosure.

FIG. 19 illustrates a second exemplary embodiment of the proposed scheduling method in accordance with the disclosure.

FIG. 20 illustrates the hardware of an exemplary user equipment in terms of functional block diagrams in accordance with the disclosure.

FIG. 21 illustrates the hardware of an exemplary base station in terms of functional block diagrams in accordance with the disclosure.

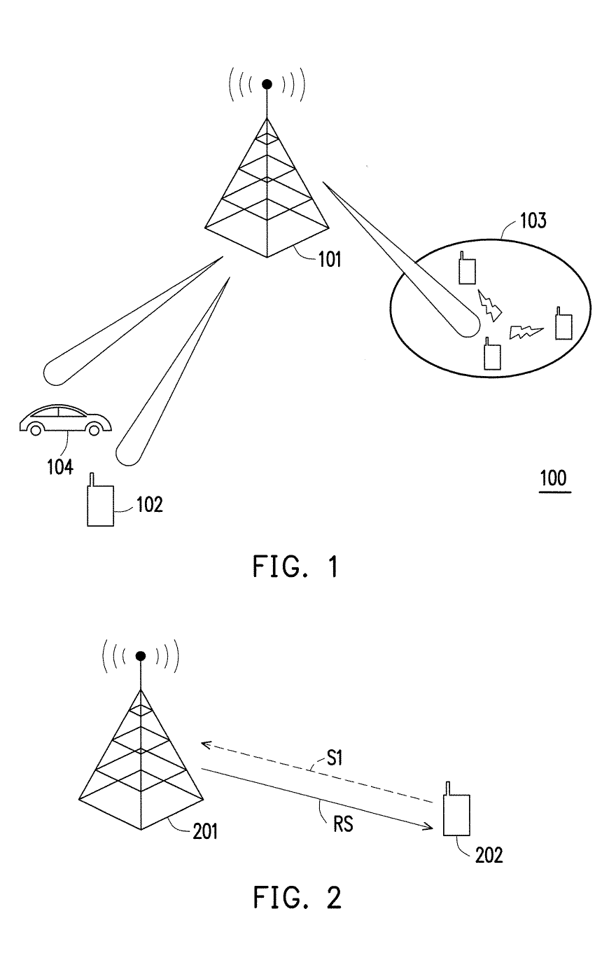

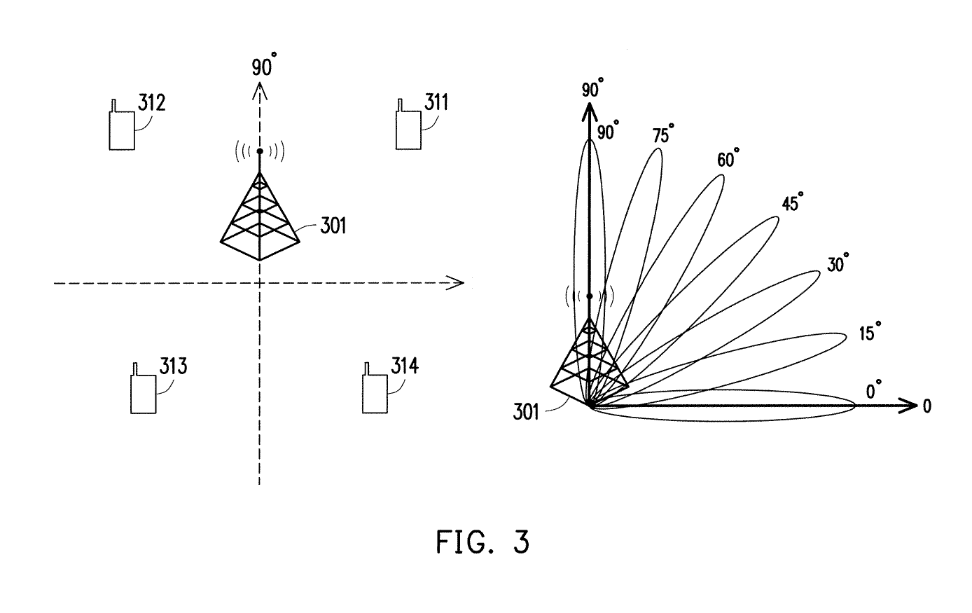

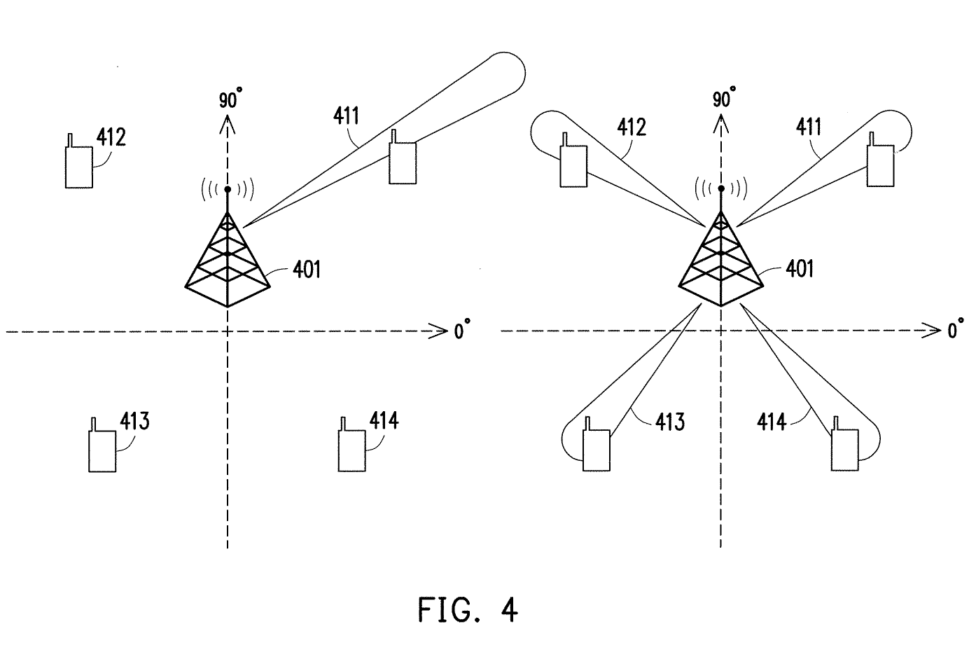

### DETAILED DESCRIPTION OF DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

The disclosure proposes a scheduling mechanism which is suitable for a millimeter wave (mmWave) cellular communication system that uses a directional reference signal. As directional signals are being utilized to cover user equipment (UEs) located in various directions relative to a base station which transmits the reference signals, the UEs that are waiting to be covered by one of the reference signals could be put in a power saving mode or sleep mode in order to reduce power consumption. Also as described previously, there could be a channel information feedback delay after a channel measurement is performed by a UE based on the received reference signal. The delay of the channel state information feedback might result in performance degradation for subsequent scheduling. Therefore, the disclosure proposes a scheduling method to address such issues.

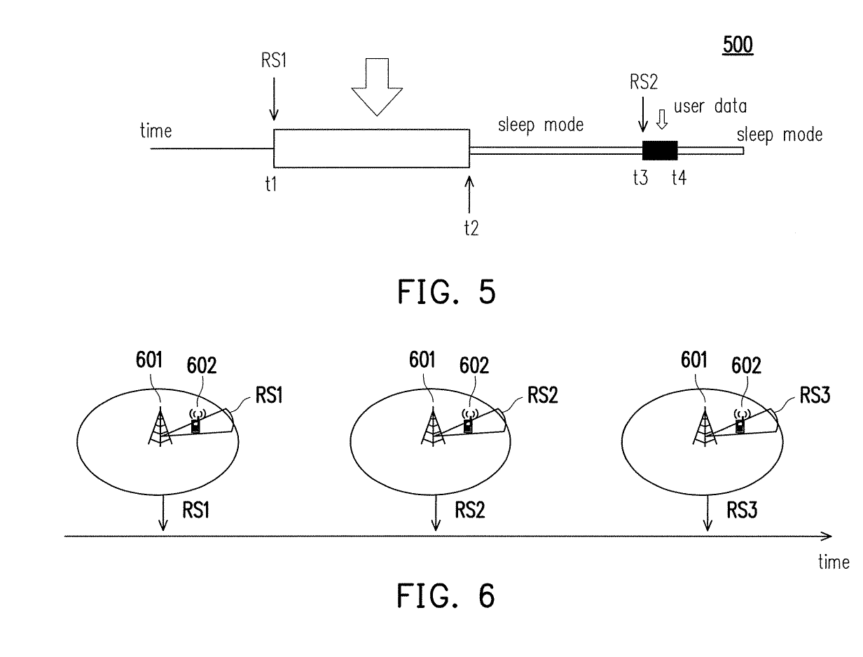

In general, an eNB or a base station in the future such as an mmWave macro cell base station is assumed to transmit reference signals that are not broadcasted in all directions but are directional in nature. A mmWave devices or mmWave UEs could receive such reference signals and perform channel measurements based on the received reference signals in order to generate channel state information (CSIs). The mmWave devices would then feedback the CSIs back to the mmWave macro cell base station. The CSIs could be transmitted back to the mmWave macro cell base station through a non-mmWave control channel such as a Primary Serving Cell (Pcell) in a lower frequency band while the mmWave communications transpire in a Secondary Serving Cell (Scell). An above described concept is further explained in FIG. 5.

FIG. 5 is conceptual diagram which illustrates the proposed scheduling method used by a UE that receives directional reference signals in accordance with one of the exemplary embodiments of the disclosure. First, the functional steps from the perspective of the UE are described. As the UE receives a first reference signal (RS1) before a first time period (t₁˜t₂), the UE would enter into a first schedulable period at the first time period (t₁˜t₂) after receiving the first reference signal (RS1). Subsequently, the UE would then enter into a power saving mode or sleep mode in a second time period (t₂˜t₃) which is immediately after the first time period. During the power saving mode, the UE is assumed to turn off most non-critical functions in order to reduce power consumption. The UE would then receive a second reference signal (RS2) before a third time period (t₃˜t₄). The UE would then enter into a second schedulable period at the third time period (t₃˜t₄) after receiving the second reference signal (RS2). The UE would then enter into the power saving mode in a fourth time period (t₄˜t₅) which is immediately after the third time period.

From the network perspective, after receiving the first reference signal (RS1), the UE which is assumed to be a mm-Wave device would measure the first reference signal (RS1) and transmit a CSI feedback at time t₁. An mmWave base station would then schedule user data transmission for the UE. The UE may then receive the scheduled user data during the first time period which is between t₁ and t₂ as labelled in FIG. 5. Between t₂ and t₃, the UE may enter into a power saving mode. Subsequently, the UE may wake up either before receiving the second reference signal (RS2) or wake up in response to receiving the second reference signal (RS2). Before receiving the user data however, the UE would need to be configured with parameters related to the reference signal transmission or parameters related to the user data reception such as the duration of the schedulable period (e.g. t₁˜t₂) for example. The concept as described in FIG. 5 will be further elucidated by following figures and their corresponding written descriptions.

FIG. 6 illustrates transmissions of directional reference signals in accordance with one of the exemplary embodiments of the disclosure. A base station 601 is assumed to transmit directional reference signals (RS1, RS2, RS3) to a UE 602 periodically. For example, the base station may perform a reference signal sweep clockwise or counter clockwise. The base station may also cover the entire 360 degrees of a X-Y plane with N discrete beams with each beam covering 360/N degrees, where N is a non-zero integer. The base station may also divide the N discrete beams into several groups, and thus all beams within a group may sweep simultaneously. Some examples of reference signals transmissions are provided in latter part of the disclosure.

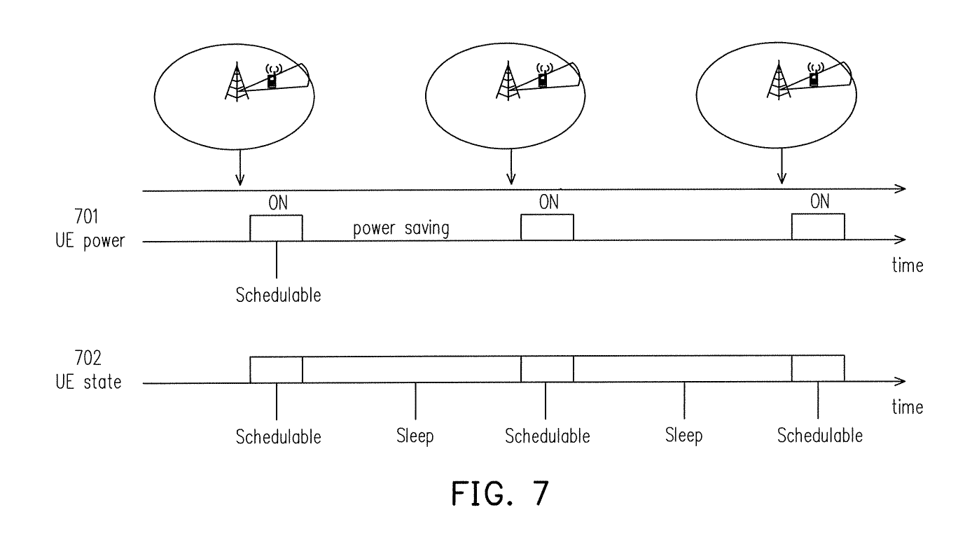

FIG. 7 illustrates the proposed scheduling method used by a UE that receives directional reference signals with more details in accordance with one of the exemplary embodiments of the disclosure. After the UE 602 has received reference signals (e.g. RS1, RS2, RS3) from the base station 601, the UE 602 would perform a channel measurement based on the reference signals to generate CSIs. The UE 602 would then transmit the CSIs back to the base station 601. Based on the received CSIs, the base station 601 may then schedule user data transmissions during schedulable periods. For the example of FIG. 7, after the reference signal RS1 is received, the UE power 701 would be on in order to receive the reference signals, perform measurements, and subsequently transmit and receive user data from the base station 601. As seen in FIG.7, after the UE power 701 has been in the “on” state for a specific period, the UE power 701 would enter a power saving mode. Such iteration may continue after receiving each reference signals subsequently (e.g. RS2, RS3, and etc.). Moreover, after the reference signal RS1 is received, the UE state 702 may enter a schedulable state for a specific period. During the schedulable state, the UE 702 could be scheduled to transmit and receive user data from the base station 601. Right after the schedulable state, as shown in FIG. 7, the UE state 702 may enter into a sleep state or a power saving mode. Such iteration may continue after receiving each reference signals subsequently (e.g. RS2, RS3, and etc.).

In general, if a UE is described as being schedulable (e.g. at time t) in this disclosure, the UE is eligible to receive data transmission from a base station, an access point, or another UE (at time t). The term schedulable time refers to a continuous time period when a UE is schedulable. A schedulable time could be configured with a pattern such as repeating periodically. A schedulable device set refers to a set of UEs that are schedulable at a given moment. A base station ay schedule data transmission for any UE or all UEs within the schedulable device set.

A UE could be given higher scheduling priority if the UE has more recent channel measurement results. For example, a UE could be given higher scheduling priority if the time between the reference signal measurement and the time of scheduling data transmission is less than other UEs. The schedulable time could be configured for each UE after a reference signal measurement has been performed, and the schedulable time may begin as soon as the UE receives a reference signal. When the UE is not in a schedulable time, the UE may enter into a sleep mode or a power saving state. A base station may schedule UE which is currently in a schedulable time. A base station may select a UE from a schedulable device set for data transmission. A base station may group UEs with overlapping schedulable time into a schedulable device set for scheduling. A schedulable time duration could be fixed length or variable length. A schedulable time could be configured by a base station or by a UE in its own accord.

In one of the exemplary embodiments, a base station might transmit a control message to a UE or to a group of UEs to configure parameters related to the length and the time of occurrence of a schedulable tune. In another one of the exemplary embodiments, a UE may calculate the preferred length of schedulable time and transmits the value in a control message to its serving base station. The serving base station could then use the value in the control message without modification. Alternatively, the serving base station may adjust the value and notify the final value to the UE through another control signaling message. The aforementioned concepts would be further expanded upon in subsequent exemplary embodiments.

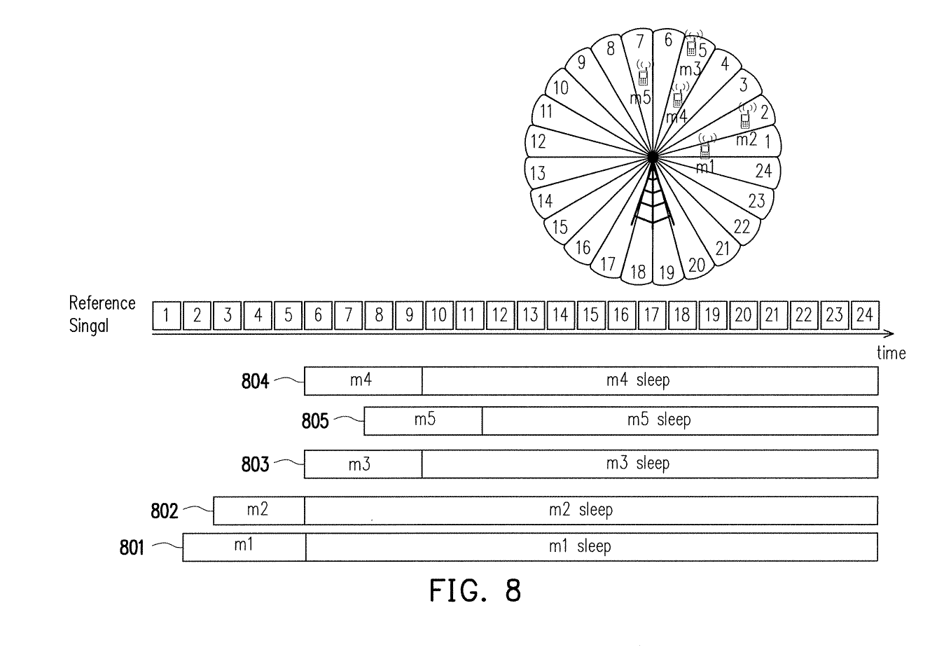

FIG. 8 illustrates schedulable time for each UE in accordance with one of the exemplary embodiments of the disclosure. For this exemplary embodiment, it is assumed that a base station covers the entire 360 degrees of space with 24 reference signals. The base station may complete a full sweep by transmitting a reference signal at a time or by transmitting multiple reference signals in a group. For illustration purposes, it is also assumed that the base station would provide coverage for 5 different UEs labelled m1, m2, m3, m4, and m5 in FIG. 8. The schedulable time for each UE could be set right after the expected time of receiving each directional reference signal. If a UE is not in any schedulable time, the UE would enter into a sleep mode.

Assuming that the base station transmits 24 reference signals in 24 time slots, as the m1 receives reference signal (RS) 1 in the first time slot, the first schedulable time 801 for m1 would start at the beginning of the second time slot and would span from the beginning of the second time slot to the end of the fifth time slot for a total of 4 time slots. As m2 receives the RS 2 in the second time slot, the second schedulable time 802 for m2 would start at the beginning of the third time slot and would span from the beginning of the third time slot to the end of the fifth time slot for a total of 3 time slots. As the m3 receives the RS 5 in the fifth time slot, the third schedulable time 803 for m3 would start at the beginning of the sixth time slot and would span from the beginning of the sixth time slot to the end of the ninth time slot for a total of 4 time slots. As m4 receives the RS 5 in the fifth time slot, the fourth schedulable time 804 for m4 would start at the beginning of the sixth time slot and would span from the beginning of the sixth time slot to the end of the ninth tune slot for a total of 4 time slots. As m5 receives the RS 7 in the seventh time slot, the fifth schedulable time 805 for m5 would start at the beginning of the eighth time slot and would span from the beginning of the eighth time slot to the end of the eleventh time slot for a total of 4 time slots. Immediately after the schedulable time 801 802 803 804 805, the UEs m1 m2 m3 m4 m5 respectively would enter into sleep state or a power saving mode.

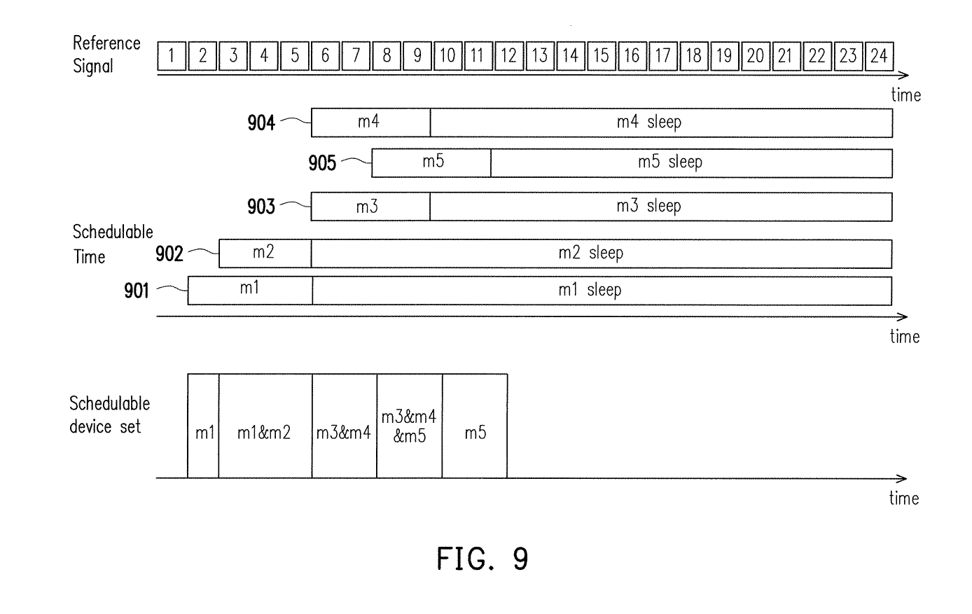

FIG. 9 illustrates determining schedulable device sets in accordance with one of the exemplary embodiments of the disclosure. Assuming that the schedulable times for m1, m2, m3, m4, and m5 are time periods 901, 902, 903, 904, and 905 respectively, a base station may schedule one UE or multiple UEs concurrently as a schedulable device set (or simply as a group) if the multiple UEs have overlapping schedulable time. In this exemplary embodiment, the first schedulable device set (SD1) is configured during only the second time slot and contains only m1 since m1 does not have overlapping schedulable time with other devices. The second schedulable device set (SD2) is configured during only between the third time slot and the fifth time slot and contains m1 & m2 since these two devices have overlapping schedulable time. Based on the same principle, the third schedulable device set (SD3) is configured during only between the sixth time slot and the seventh time slot and contains m3 & m4. The fourth schedulable device set (SD4) is configured during only between the eighth time slot and the ninth time slot and contains m3 & m4 & m5. The fifth schedulable device set (SD5) is configured only between the tenth and eleventh time slot and contains m5 only. Immediately after the schedulable time 901 902 903 904 905, the UEs m1 m2 m3 m4 m5 respectively would enter into sleep state or a power saving mode.

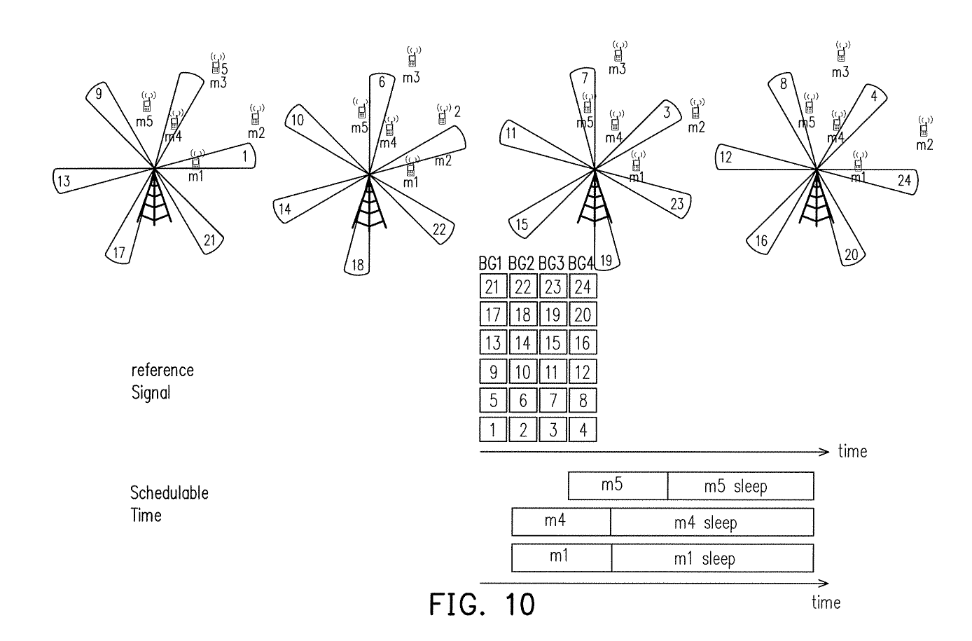

Alternative or in addition to the exemplary embodiment in which the schedulable devices with overlapping schedulable time are grouped into a scheduling group or a schedulable device set, UEs that are covered by the same directional reference signal beam may also be grouped into a scheduling group or a schedulable device set. Also alternatively or additionally, UEs covered by several adjacent directional beams could also be grouped together into a scheduling group or a schedulable device set. FIG. 10 illustrates determining schedulable tithe according to reference signal beam groups in accordance with one of the exemplary embodiments of the disclosure. In this exemplary embodiment, reference signal beams are grouped into M groups and reference signals from the same group is transmitted simultaneously. For this particular example as shown in FIG. 10, there are 24 reference signals divided into 4 groups transmitted at four different time slots with each group having 6 reference signals transmitted simultaneously. For example the reference signal group 1 (BG1) would contain reference signals 1, 5, 9, 13, 17, and 21 transmitted at the same time slot. Notice that m1 is covered by RS 1 and m4 is covered by RS5, and RS1 and RS5 are transmitted on the same time slot; therefore, m1 and m4 could be grouped into the same scheduling group to transmit or receive during the schedulable period between the second time slot and the fourth time slot. After the schedulable period, m1 and m4 would enter into a power saving mode or sleep state. Since m5 receives RS7 during the third time slot, m5 would then be schedulable starting from the beginning of the fourth time slot for a specific duration. After the schedulable period, m5 would enter into a power saving mode or sleep state.

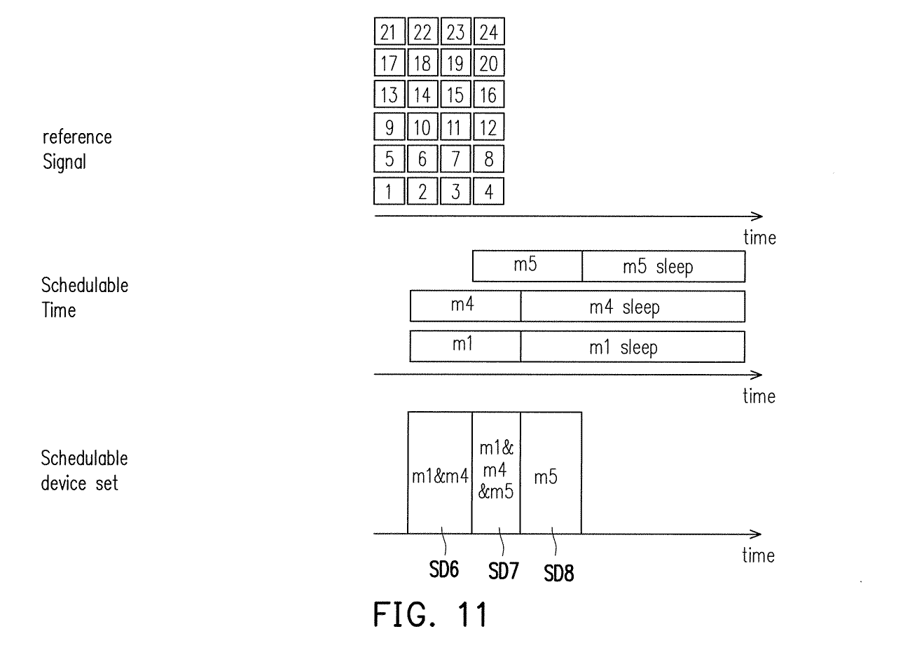

FIG. 11 illustrates determining schedulable device sets according to simultaneous reference beams in the same reference signal beam group in accordance with one of the exemplary embodiments of the disclosure. In this exemplary embodiment, a base station would group UEs that receive simultaneous reference signal beams into the same scheduling group. Therefore, based on the same example as shown in FIG. 10, the sixth schedulable device set (SD6) would contain m1 & m4 since both m1 and m4 would receive simultaneous reference signal beams. The seventh schedulable device set (SD7) would contain m1 & m4 & m5 since all these three devices have overlapping schedulable period at the same time. The eighth schedulable device set (SD8) would contain m5 only since m5 neither receives simultaneous reference signal beams with other devices nor has overlapping schedulable period with other devices.

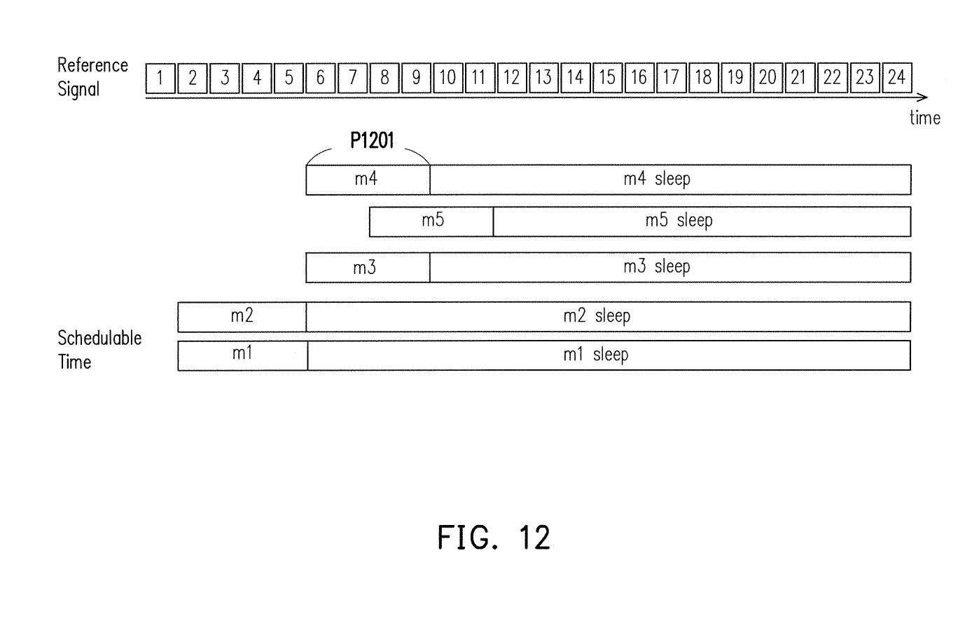

FIG. 12 illustrates fixed length schedulable time in accordance with one of the exemplary embodiments of the disclosure. In this exemplary embodiment, the schedulable time period for each of m1, m2, m3, m4, and m5 as shown in FIG. 12 is 4 time slots. For example, the schedulable time period P1201 for m4 is from the beginning of the sixth time slot to the end of the ninth time slot and is thus 4 time slots. The schedulable time periods for the rest of the UEs m1, m2, m3, and m5 are all 4 time slots. Therefore, for this exemplary embodiment, the schedulable time periods are for all the UEs have a fixed duration.

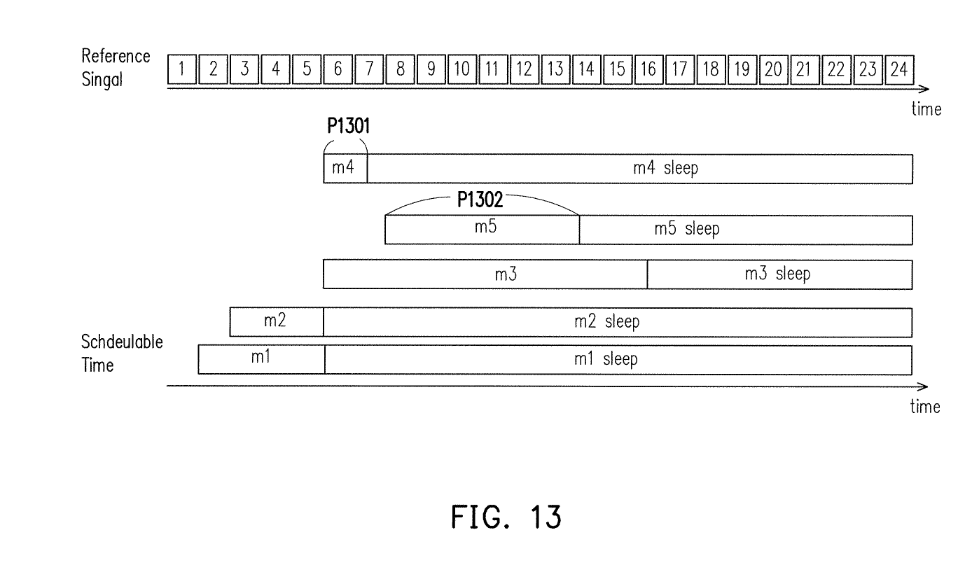

FIG. 13 illustrates variable length schedulable time in accordance with one of the exemplary embodiments of the disclosure. In this exemplary embodiment, the schedulable time period for each of m1, m2, m3, m4, and m5 as shown in FIG. 13 are variable. For example, the schedulable time period P1301 for m4 is one time slot. However, the schedulable time period P1302 for m5 spans 6 time slots. Therefore, for this exemplary embodiment, the schedulable time periods are for all the UEs may have a variable duration.

A base station may set or adjust settings and parameters related to schedulable time period and powersaving mode through various signaling means. Alternatively, a UE may report suggested settings and parameters related to schedulable time period and power saving mode, and a base station may determine the proper settings and parameters by its own determination or by adhering to the UE's report.

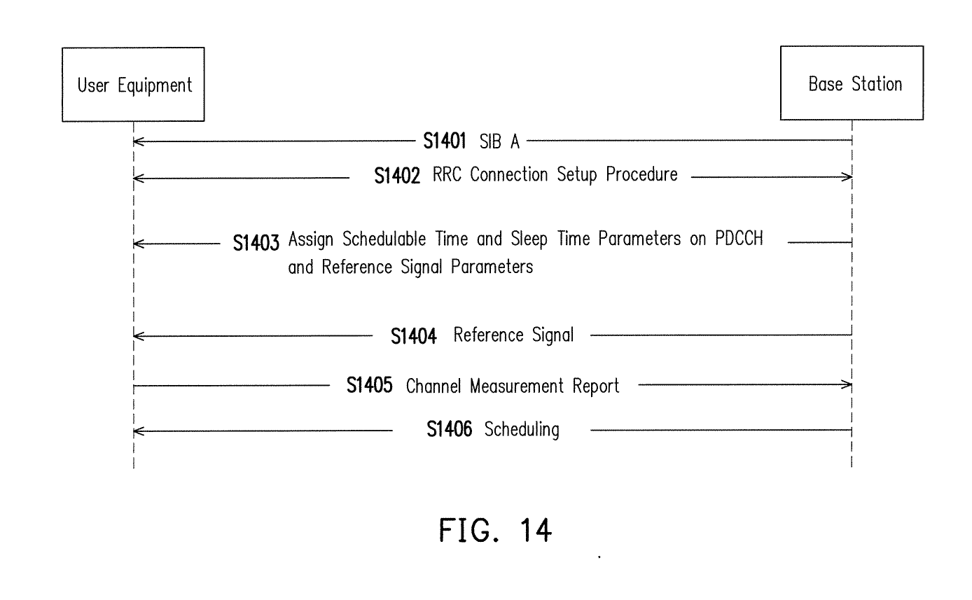

FIG. 14 illustrates a signaling diagram of a BS assigning schedulable time on PDCCH in accordance with one of the exemplary embodiments of the disclosure. In step S1401, a base station may transmit system information to UEs within the cell of the base station. The system information for this exemplary embodiment may not include any schedulable time information. In step S1402, the base station and the UE would establish a Radio Resource Control (RRC) setup procedure. In response to the RRC setup procedure being complete, in step S1403, the base station would assign parameters of schedulable time period, power saving mode, and reference signals. The UE may obtain parameters of schedulable time period, power saving mode, and reference signals by decoding a physical downlink control channel (PDCCH). The parameters of schedulable time period and power saving mode may include not limited to the starting time, the ending time, and the duration of the schedulable time period and the power saving mode. The base station may also transmit parameters of reference signals to the UE, and the parameters may include not limited to the transmission power of the reference signal and the overall number of beams, the number of beam groups, the number of beams in a beam group, and so forth. In step S1404, the base station may transmit a reference signal to the UE based on the parameters of the reference signals communicated to the UE in step S1403. In step S1405, the UE would perform channel measurements based on the reference signal and transmit a channel measurement report to the base station. In step S1406, the base station may perform the proposed scheduling method according to the channel measurement report and schedule the UE accordingly.

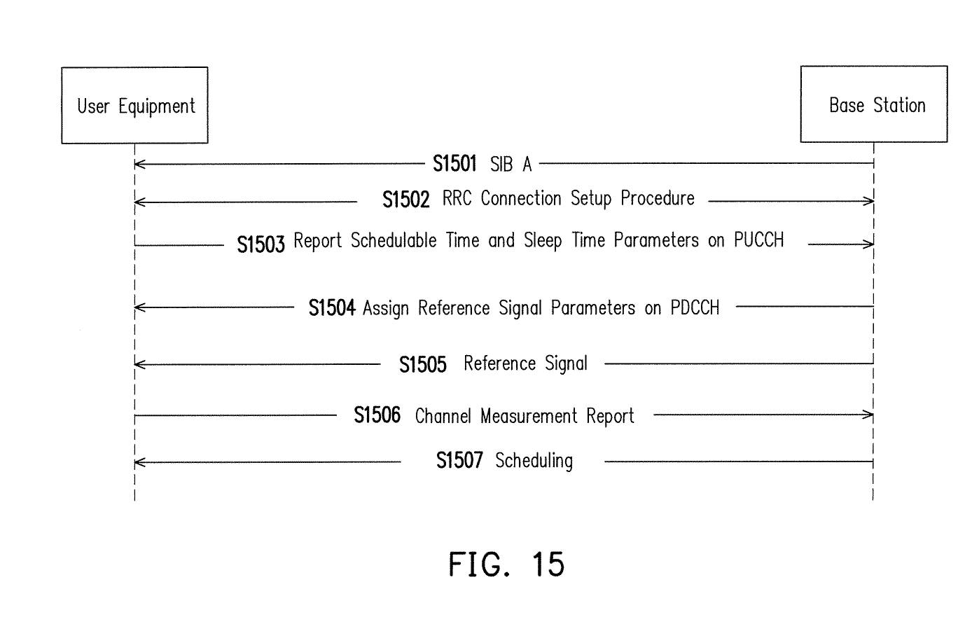

FIG. 15 illustrates a signaling diagram of a UE reporting schedulable time on PUCCH in accordance with one of the exemplary embodiments of the disclosure. In step S1501, a base station may transmit system information to UEs within the cell of the base station. The system information for this exemplary embodiment may not include any schedulable time information. In step S1502, the base station and the UE would establish a Radio Resource Control (RRC) setup procedure. In response to the RRC setup procedure being complete, in step S1503, the UE may report preferred parameters of schedulable time period and powersaving mode to the base station such as the starting time, the ending time, and the duration. The base station may obtain the preferred parameters of schedulable time period and power saving mode from the UE by reading the physical uplink control channel (PUCCH). In step S1504, the base station would assign parameters of reference signals to the UE. The UE may obtain parameters of the assigned reference signals by decoding a physical downlink control channel (PDCCH). The parameters of reference signals to the UE may include not limited to the transmission power of the reference signal and the overall number of beams, the number of beam groups, the number of beams in a beam group, and so forth. In step S1505, the base station may transmit a reference signal to the UE based on the parameters of the reference signals communicated to the UE in step S1504. In step S1506, the UE would perform channel measurements based on the reference signal and transmit a channel measurement report to the base station. In step S1507, the base station may perform the proposed scheduling method according to the channel measurement report and schedule the UE accordingly.

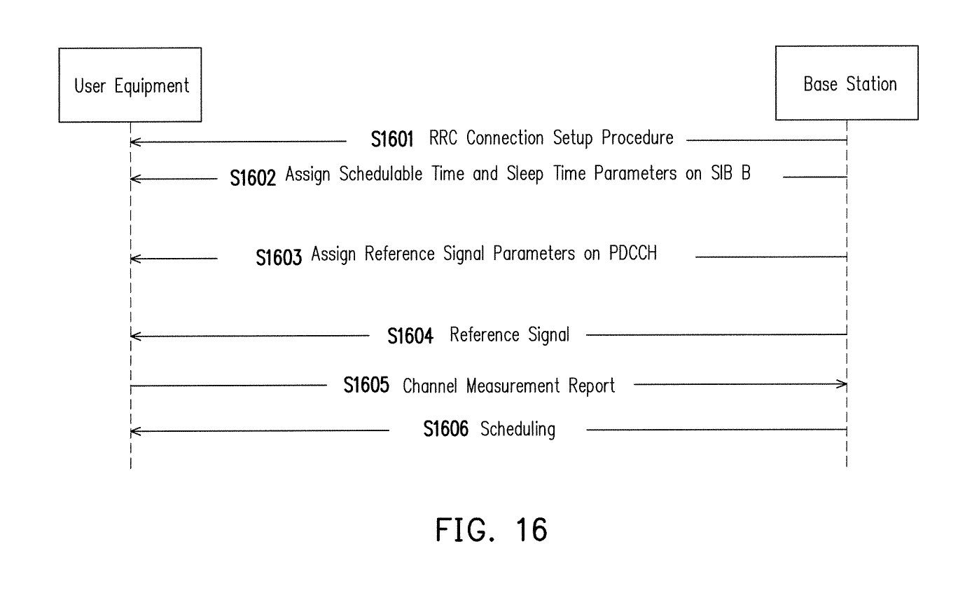

FIG. 16 illustrates a signaling diagram of using SIB for scheduling after RRC connection setup in accordance with one of the exemplary embodiments of the disclosure. In step S1601, the base station and the UE would establish a Radio Resource Control (RRC) setup procedure. In response to the RRC setup procedure being complete, in step S1602, a base station may transmit system information to UEs within the cell of the base station. The system information for this exemplary embodiment would include schedulable time information which could be embedded within an information element of a new or existing system information block. The schedulable time information may include not limited to parameters of schedulable time period and power saving mode such as the starting time, the ending time, and the duration. In step S1603, the base station would assign parameters of reference signals to the UE. The UE may obtain the parameters of assigned reference signals by decoding a physical downlink control channel (PDCCH). The parameters of reference signals to the UE may include not limited to the transmission power of the reference signal and the overall number of beams, the number of beam groups, the number of beams in a beam group, and so forth. In step S1604, the base station may transmit a reference signal to the UE based on the parameters of the reference signals communicated to the UE in step S1603. In step S1605, the UE would perform channel measurements based on the reference signal and transmit a channel measurement report to the base station. In step S1606, the base station may perform the proposed scheduling method according to the channel measurement report and schedule the UE accordingly.

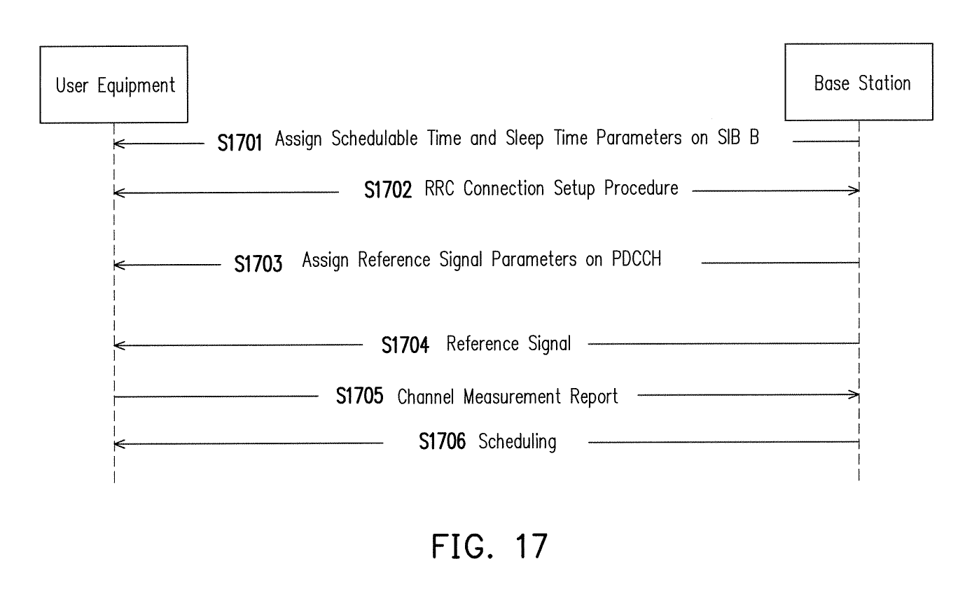

FIG. 17 illustrates a signaling diagram of using SIB for scheduling before RRC connection setup in accordance with one of the exemplary embodiments of the disclosure. In step S1701, a base station may transmit system information to UEs within the cell of the base station. The system information for this exemplary embodiment would include schedulable time information which could be embedded within an information element of a new or existing system information block. The schedulable time information may include not limited to parameters of schedulable time period and power saving mode such as the starting time, the ending time, and the duration. In step S1702, the base station and the UE would establish a Radio Resource Control (RRC) setup procedure. In step S1703, the base station would assign parameters of reference signals to the UE. The UE may obtain the parameters of assigned reference signals by decoding a physical downlink control channel (PDCCH). The parameters of reference signals to the UE may include not limited to the transmission power of the reference signal and the overall number of beams, the number of beam groups, the number of beams in a beam group, and so forth. In step S1704, the base station may transmit a reference signal to the UE based on the parameters of the reference signals communicated to the UE in step S1703. In step S1705, the UE would perform channel measurements based on the reference signal and transmit a channel measurement report to the base station. In step S1706, the base station may perform the proposed scheduling method according to the channel measurement report and schedule the UE accordingly.

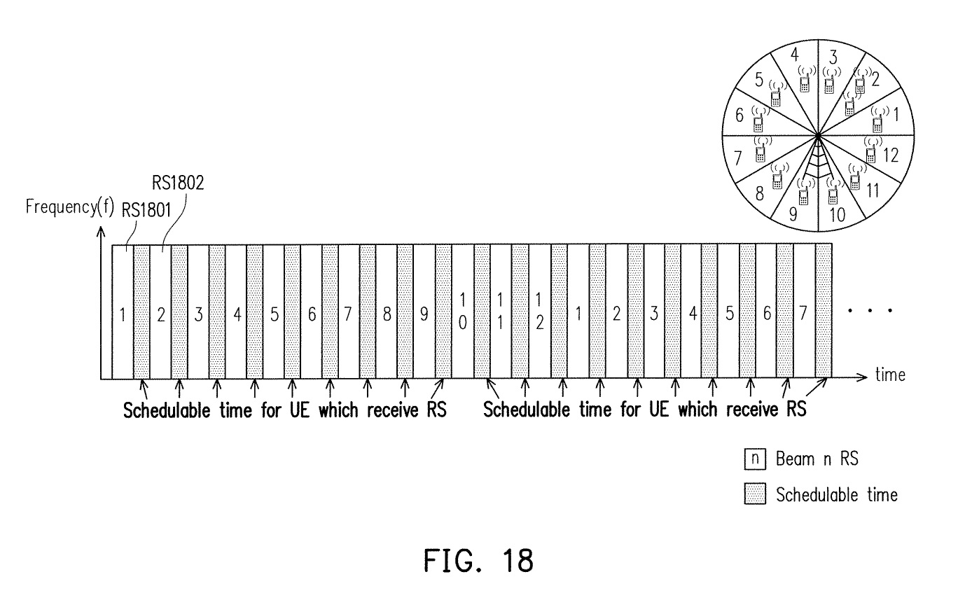

FIG. 18 illustrates a first exemplary embodiment of the proposed scheduling method in accordance with the disclosure. In this exemplary embodiment, a base station would perform a complete sweep of reference signals by transmitting a number of reference signals sequentially. In this particular example, the base station would transmit 12 reference signals sequentially in 12 different directions in order to provide a full coverage. From the timing diagram of FIG. 12, it can be seen that the time slots for the schedulable time period for the UE could be interleaving with the time slots in which reference signals are received. Subsequent to the schedulable time period, the UE may not have to enter into the sleep state or the power saving mode. For example, after the RS 1801 has been received, the UE would be schedulable in response to receiving the RS1801. After being schedulable, the UE would user data or payload that has been scheduled without entering into the sleep state or the power saving mode.

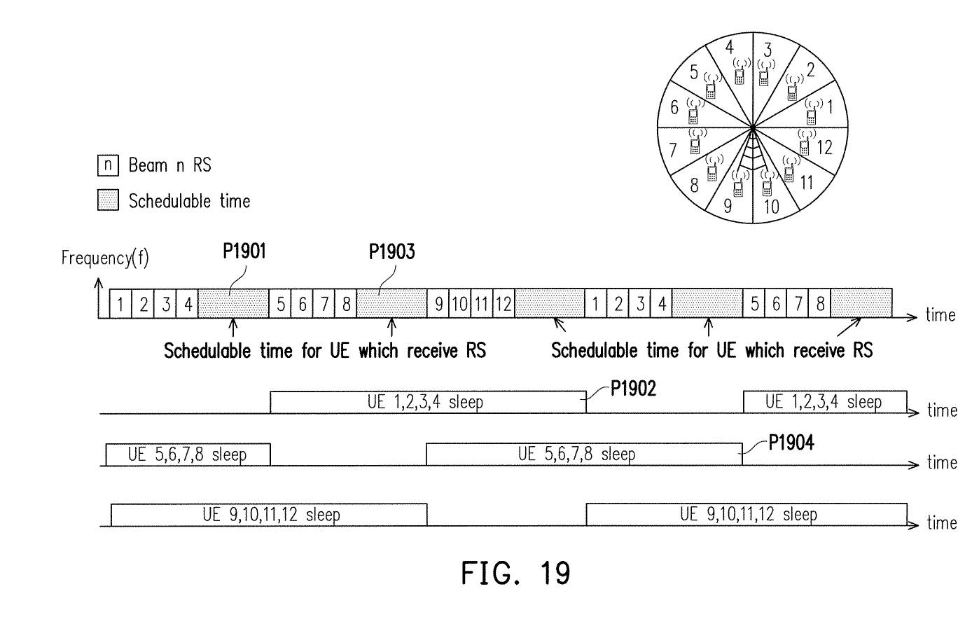

FIG. 19 illustrates a second exemplary embodiment of the proposed scheduling method in accordance with the disclosure. For this exemplary embodiment, a full sweep of directional reference signals may interleave with schedulable time periods during which one or more UEs may transmit or receive user data from the base station. In this particular example, after reference signal 1, 2, 3, and 4 are transmitted by the base station and received by UEs 1, 2, 3, and 4 respectively, in period P1901, UEs 1, 2, 3, and 4 would be enter into a schedulable period during which these UEs may transmit or receive user data from the base station. Subsequent to the period P1901, in period P1902, UEs 1, 2, 3, and 4 would entering into a power saving mode or sleep state. Subsequent to period P1901, the base station would transmit reference signals 5, 6, 7, and 8 which are received by UE 5, 6, 7, and 8. During period P1903, UEs 5, 6, 7, and 8 would be enter into a schedulable period during which these UEs may transmit or receive user data from the base station. During period P1904, UEs 5, 6, 7, 8 would enter into a power saving mode or sleep state. This pattern may repeat until a full sweep is completed. After a full sweep is completed, the same pattern may repeat for a number of times.

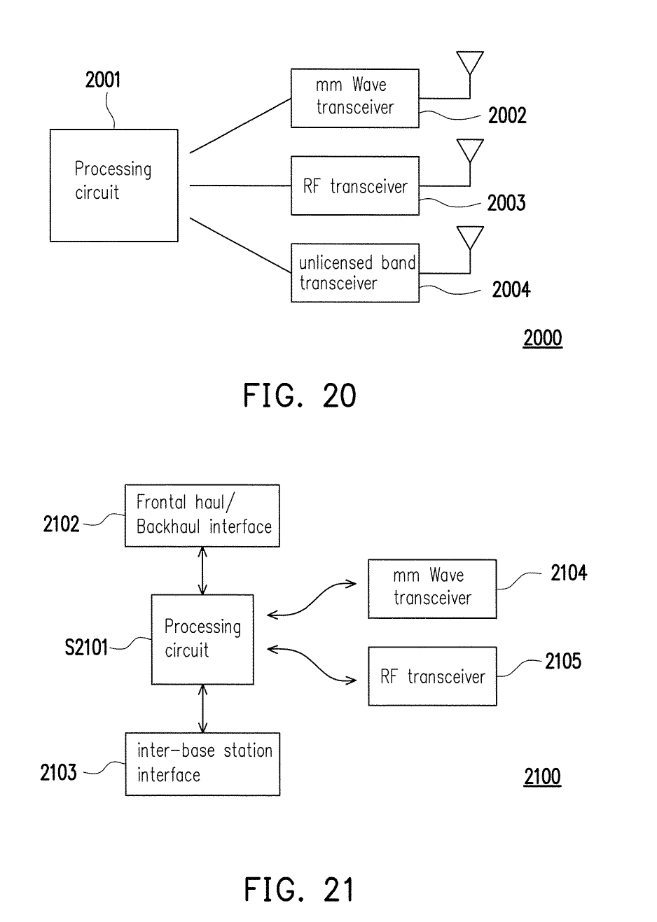

FIG. 20 illustrates the hardware of an exemplary user equipment (UE) in terms of functional block diagrams in accordance with the disclosure. The exemplary UE may include not limited to a processing circuit 2001 electrically coupled to a mmWave transceiver 2002, a RF transceiver 2003, and a unlicensed band transceiver 2004. The mmWave transceiver 2002 may include a mmWave transmitter and a mmWave receiver for transmitting and receiving wireless signals in the mmWave spectrum. The RF transceiver 2003 may include a RF transmitter and a RF receiver for transmitting and receiving wireless signals in the 3G/4G/LTE spectrums. The unlicensed band transceiver may include a Wi-Fi transceiver and/or a Bluetooth transceiver. The processing circuit 2001 would be used to implement the proposed scheduling method used by a UE that receives directional reference signals. The processing circuit 2001 may include one or more central processing unit (CPU), microcontroller units (MCU), or other types of programmable integrated circuits.

FIG. 21 illustrates the hardware of an exemplary base station in terms of functional block diagrams in accordance with the disclosure. The base station may include not limited to a processing circuit 2101 electrically coupled to a front/back haul transceiver interface 2102, an inter-base station interface 2103, a mmWave transceiver 2104, and a RF transceiver 2105. The front/back haul transceiver interface 2102 could be hardware circuit configured to communicate with the core network according to a front/back haul standard such as the S1 interface. The inter-base station interface 2103 could be hardware circuit configured to communicate with another base station such as an X2 interface. The mmWave transceiver 2104 may include a mmWave transmitter and a mmWave receiver for transmitting and receiving wireless signals in the mmWave spectrum. The RF transceiver 2105 may include a RF transmitter and a RF receiver for transmitting and receiving wireless signals in the 3G/4G/LTE spectrums. The processing circuit 2101 would be used to implement the proposed scheduling method used by a base station that transmits directional reference signals. The processing circuit 2101 may include one or more central processing unit (CPU), microcontroller units (MCU), or other types of programmable integrated circuits.

In view of the aforementioned descriptions, the present disclosure is suitable for being used in a wireless communication system and is able to schedule data transmission in a way that is not affected by the CSI feedback delay and is also power efficient.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A scheduling method used by a UE that receives directional reference signals, the method comprising:
receiving a first reference signal before a first time period;
entering into a first schedulable period at the first time period after receiving the first reference signal;
entering into a power saving mode in a second time period which is immediately after the first time period;
receiving a second reference signal before a third time period;
entering into a second schedulable period at the third time period after receiving the second reference signal; and
entering into the power saving mode in a fourth time period which is immediately after the third time period.

2. The method of claim 1, wherein
entering into the first schedulable period comprising:
transmitting or receiving a first user data during the first time period; and
entering into the second schedulable period comprising:
transmitting or receiving a second user data during the third time period.

3. The method of claim 2, wherein the first schedulable period has the same duration as the second schedulable period.

4. The method of claim 2, wherein the first schedulable period has a different duration from the second schedulable period.

5. The method of claim 2, wherein transmitting or receiving the first user data during the first time period further comprising:
transmitting or receiving the first user data during the first time period with other UEs grouped as a first schedulable device set, wherein the first schedulable device set comprises UEs covered by a same reference signal beam.

6. The method of claim 2, wherein transmitting or receiving the first user data during the first time period further comprising:
transmitting or receiving the first user data during the first time period with other UEs grouped as a second schedulable device set, wherein the second schedulable device set comprises UEs covered by adjacent reference signal beams.

7. The method of claim 2 further comprising:
receiving parameters of the first schedulable period and parameters of the first reference signal through a physical downlink control channel (PDCCH).

8. The method of claim 2 further comprising:
transmitting parameters of the first schedulable period and parameters of the first reference signal through a physical uplink control channel (PUCCH).

9. The method of claim 2 further comprising:
completing a radio resource control (RRC) setup procedure; and
receiving parameters of the first schedulable period and parameters of the first reference signal through a system information block (SIB) after completing the RRC setup procedure.

10. The method of claim 2 further comprising:
receiving parameters of the first schedulable period and parameters of the first reference signal through a system information block (SIB); and
completing a radio resource control (RRC) setup procedure after receiving the parameters of the first schedulable period and the parameters of the first reference signal.

11. A scheduling method used by a base station that transmits directional reference signals, the method comprising:
transmitting a first reference signal before a first time period;
transmitting a first user data in a first schedulable period at the first time period after transmitting the first reference signal;
stopping transmitting the first user data after the first schedulable period a second time period which is immediately after the first time period;
transmitting a second reference signal before a third time period;
transmitting a second user data at the third time period after transmitting the second reference signal; and
stopping transmitting the second user data in a fourth time period which is immediately after the third time period.

12. The method of claim 11, wherein the first schedulable period has the same duration as the second schedulable period.

13. The method of claim 11, wherein the first schedulable period has a different duration from the second schedulable period.

14. The method of claim 11, wherein transmitting the first user data during the first time period comprising:
transmitting the first user data to a first user equipment (UE) grouped into a first schedulable device set, wherein the first schedulable device set comprises UEs covered by a same reference signal beam.

15. The method of claim 11, wherein transmitting the first user data during the first time period comprising:
transmitting the first user data to a second user equipment (UE) grouped into a second schedulable device set, wherein the second schedulable device set comprises UEs covered by adjacent reference signal beams.

16. The method of claim 11 further comprising:
transmitting parameters of the first schedulable period and parameters of the first reference signal through a physical downlink control channel (PDCCH).

17. The method of claim 11 further comprising:
receiving parameters of the first schedulable period and parameters of the first reference signal through a physical uplink control channel (PUCCH).

18. The method of claim 11 further comprising:
completing a radio resource control (RRC) setup procedure; and
transmitting parameters of the first schedulable period and parameters of the first reference signal through a system information block (SIB) after completing the RRC setup procedure.

19. The method of claim 11 further comprising:
transmitting parameters of the first schedulable period and parameters of the first reference signal through a system information block (SIB); and
completing a radio resource control (RRC) setup procedure after transmitting the parameters of the first schedulable period and the parameters of the first reference signal.

20. A user equipment (UE) comprising:
a receiver;
a transmitter; and
a processing circuit coupled to the receiver and the transmitter, wherein the processing circuit is configured at least to:
receive, via the receiver, a first reference signal before a first time period;
receive, via the receiver, a first user data at the first time period after receiving the first reference signal;
enter into a power saving mode in a second time period which is immediately after the first time period;
receive, via the receiver, a second reference signal before a third time period;
receive, via the receiver, a second user data at the third time period after receiving the second reference signal; and
enter into the power saving mode in a fourth time period which is immediately after the third time period.
